(19) United States
(12) Patent Application Publication
(10) Pub. No.: US 2025/0141774 A1
(43) Pub. Date: May 1, 2025

(54) TRACING THE PATH OF A LOOP IN A NETWORK

(71) Applicant: Hewlett Packard Enterprise Development LP, Spring, TX (US)

(72) Inventors: Rashmi V, Bengaluru (IN); Rajeev Jain, Bengaluru (IN)

(21) Appl. No.: 18/495,348

(22) Filed: Oct. 26, 2023

(51) Int. Cl. H04L 43/10; H04L 43/12

(52) U.S. Cl. CPC H04L 43/10; H04L 43/12

(57) ABSTRACT

A network device that can trace the path of a network loop is provided. During operation, the network device can receive a probe packet from an originating network device (OND) via an ingress port of the network device. Here, the probe packet can include a source address of the OND. The network device can determine whether the network device is the OND by comparing the source address with a local address. Upon determining that the network device is not the OND, the network device can append the local address in a payload of the probe packet and forward the probe packet via an egress port based on the destination address. On the other hand, upon determining that the network device is the OND, the network device can determine presence of a loop associated with the network device and determine a trace path of the loop based on the payload.

### BACKGROUND

A switch in a network may support different protocols and services. One such service can be loop prevention in the network to avoid packet duplication. For example, the switch can execute one or more protocol instances to detect and prevent loops in the network.

### BRIEF DESCRIPTION OF THE FIGURES

FIG. 1A illustrates an example of a probe packet traversing a network to trace the path of a loop, in accordance with an aspect of the present application.

FIG. 1B illustrates an example of determining the trace path of a loop in a network based on a probe packet, in accordance with an aspect of the present application.

FIG. 2 illustrates an example of a probe packet with a maximum transmission unit (MTU) traversing a network to trace the path of a loop, in accordance with an aspect of the present application.

FIG. 3 illustrates examples of trace data accumulation in a probe packet, in accordance with an aspect of the present application.

FIG. 4 presents a flowchart illustrating the process of a network device determining the trace path of a loop in a network, in accordance with an aspect of the present application.

FIG. 5 presents a flowchart illustrating the process of a network device processing a probe packet for determining the trace path of a loop in a network, in accordance with an aspect of the present application.

FIG. 6 illustrates an example of a network device that supports tracing the path of a loop in a network, in accordance with an embodiment of the present application.

In the figures, like reference numerals refer to the same figure elements.

### DETAILED DESCRIPTION

A network is typically formed when several network devices (e.g., switches) are coupled to each other via links. If the network is configured to include multiple paths between two network devices, the network may include a loop. In particular, the loop may occur in the network if there are multiple layer-2 paths between at least two network devices of the network. Multiple paths to a network device, even though they may cause a loop in the network, can often be desirable to facilitate high availability to the network devices through redundancy.

The loop may cause a network device to receive the packet from multiple paths. Processing the duplicate packets can impose additional overhead on the network device. Furthermore, layer-2 packet forwarding can rely on layer-2 address learning (e.g., media access control (MAC) address learning). However, if the network device learns the same address from multiple ports associated with multiple paths, the network device may repeatedly and frequently update the layer-2 forwarding table, which can cause instability in the network.

In addition, the network device can receive a layer-2 multi-destination packet, such as a broadcast, unknown unicast, or multicast packet, via an ingress port on a virtual local area network (VLAN). The network device can then flood the network by transmitting via all other ports on the VLAN. A loop in the network can cause the packet to return to the network device, which, in turn, can flood the network again. This can create a broadcast storm in the network. Therefore, detecting and preventing a loop in a network is essential. Typically, the network may deploy a Spanning-Tree protocol (STP) to determine a loop-free layer-2 topology in the network. However, if a loop exists in the network (e.g., due to a configuration error), STP may not identify which switches and ports are in the loop.

The aspects described herein address the problem of efficiently tracing the path of a loop in a network by (i) accumulating, in a probe packet sent by an originating network device (OND), information associated with a respective network device forwarding the probe packet; (ii) retrieving the accumulated information from the probe packet at the OND of the probe packet; and (iii) determining the trace path of the loop traversed by the probe packet based on the accumulated information. The information associated with a network device can include a data set comprising an address of the network device. The OND receiving the probe packet back from the network can indicate the existence of a loop in the network. Because a respective network device forwarding the probe packet can append its address in the probe packet, the probe packet can include respective addresses of the sequence of network devices that have forwarded the probe packet. As a result, if the OND receives the probe packet back on a loop, the OND can determine the trace path of the loop by tracing the path formed by the sequence of network devices.

With existing technologies, loop prevention and detection protocols, such as STP, are used to prevent a loop in a network. In addition, a network device may detect a loop in a network if the network device receives a packet originally sent by the network device (i.e., the packet's source address corresponds to the address of the network device). Nevertheless, these protocols and techniques are not able to determine the path of the loop, which can also be referred to as the loop path. The loop path can be formed by the network devices in the loop and the links coupling them. The loop may be caused by a configuration error on any of the network devices in the loop path. Therefore, the network device detecting the loop may not be the misconfigured device causing the loop. As a result, without determining which network devices are in the loop path, an administrator might not easily identify a configuration error that has caused the loop.

To address this problem, an OND can send a probe packet, which can be a loop detection packet, to the network. There can be a plurality of ONDs in the network, each sending its own probe packet. The probe packet can be a layer-2 multi-destination packet (e.g., a broadcast or multicast Ethernet frame). Hence, the destination address of the probe packet can be a multi-destination address. Furthermore, the probe packet can include the local address of the OND as the source address. For example, the source and destination addresses of the probe packet can be the OND's MAC address and a broadcast or multicast MAC address, respectively. Since the probe packet can be a layer-2 packet, the probe packet can be associated with a particular VLAN. The OND can then forward the probe packet via a respective local port of the OND configured with the VLAN. Therefore, the OND may separately probe each VLAN configured on the OND by sending a probe packet for each VLAN.

When a network device receives the probe packet, the network device can increment a hop count in the network device and append a data set associated with the network device in the payload of the probe packet. The data set can include an ingress port identifier, an egress port identifier, and a MAC address of the network device. The data set can also include neighbor information obtained from an egress or ingress port. The neighbor information can include information obtained from the Link Layer Discovery Protocol (LLDP) of a neighbor device reachable via the ingress or egress port of the probe packet. The data set included in the payload can be encoded in a type-length-value (TLV) field. The data set can be included in one TLV field, or each piece of information (e.g., an address or a port identifier) in the data set can be included in a separate TLV field.

If the MTU, which is the maximum length supported by a layer-2 packet, is reached for the probe packet, the network device can increment the hop count without appending the data set. If a network device receiving the probe packet does not support the packet format, the network device can still flood the probe packet in the network based on the destination address. As a result, if another network device that supports the packet format receives the probe packet, it can continue to append its data set. Because the probe packet is flooded to all network devices configured with the VLAN in the network, the probe packet can eventually return to the OND if there is a loop in the network.

When the OND receives the probe packet back, the OND can retrieve the data sets from the payload and parse the retrieved data sets. Since each network device forwarding the probe packet appends its data set, the retrieved data sets can indicate the sequence of network devices in the loop path starting from the OND. For each network device of the sequence, the data set can also indicate which ports have received and forwarded the probe packet. Based on the sequence of network devices and their corresponding ingress and egress ports, the OND can determine the trace path of the loop, which is the path determined by tracing the loop. The OND can then present the trace path to a network administrator for a mitigating action. For example, the OND can provide the trace path to a network management system (NMS), such as a network orchestrator. The NMS can present the trace path to the administrator via an interface (e.g., a graphical user interface). The administrator can then analyze the network devices on the loop path and determine the mitigating action (e.g., disabling a port).

In this disclosure, the term “switch” is used in a generic sense, and it can refer to any standalone network device or fabric device operating in any network layer. “Switch” should not be interpreted as limiting examples of the present invention to layer-2 networks. Any device that can forward traffic to an external device or another switch can be referred to as a “switch.” If the switch is a virtual device, the switch can be referred to as a virtual switch.

Furthermore, if a network device facilitates communication between networks, the network device can be referred to as a gateway device. Any physical or virtual device (e.g., a virtual machine or switch operating on a computing device) that can forward traffic to an end device can be referred to as a “network device.” Examples of a “network device” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

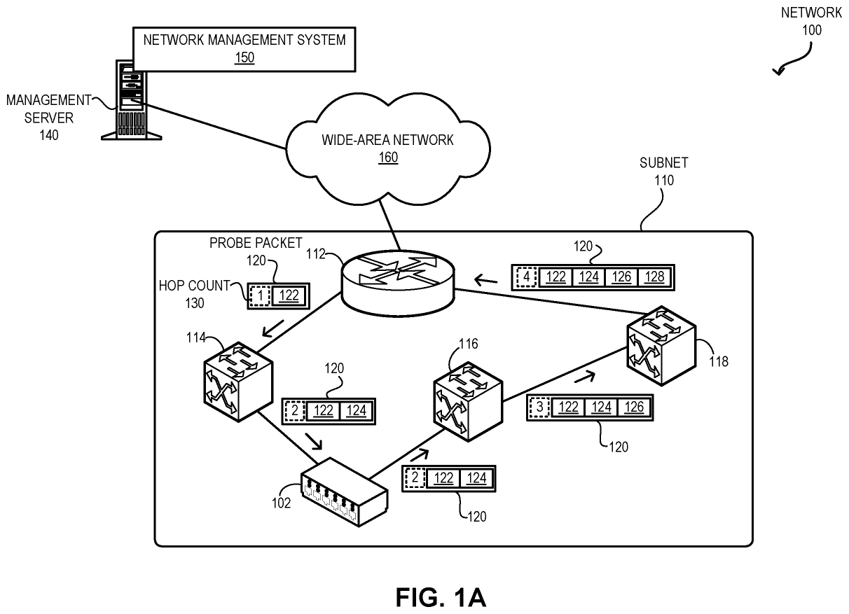

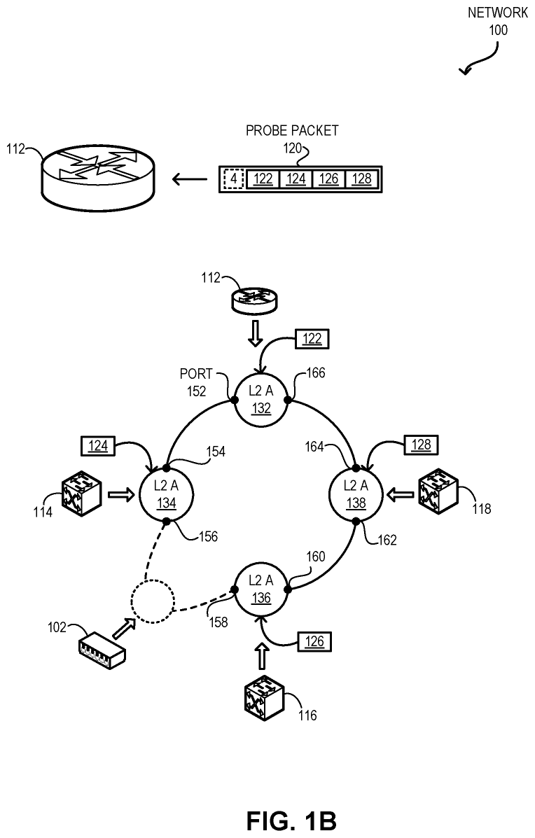

FIG. 1A illustrates an example of a probe packet traversing a network to trace the path of a loop, in accordance with an aspect of the present application. A network 100 can include a number of network and user (or end) devices, and may include heterogeneous network components, such as layer-2 and layer-3 hops and tunnels. In some examples, network 100 can be an Ethernet, InfiniBand, or other network, and may use a corresponding communication protocol, such as Internet Protocol (IP), FibreChannel over Ethernet (FCOE), or other protocol. Network 100 can include a plurality of subnets, such as subnet 110. A respective subnet of network 100 can correspond to a VLAN. Subnet 110 can include network devices 112, 114, 116, and 118. Network devices 114 and 116 can be coupled to each other via an external network device 102 (e.g., a customer switch). A respective network device in network 100 can be associated with a MAC address and an IP address.

In network 100, subnet 110 can be extended over one or more tunnels. One or more pairs of network devices of subnet 110 can then be coupled to each other via a tunnel. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). The tunnels extending subnet 110 can be formed over an underlying network (or an underlay network). The underlying network can be a physical network, and a respective link of the underlying network can be a physical link. A respective switch pair in the underlying network can be a Border Gateway Protocol (BGP) peer.

Network device 112 can be a gateway device in subnet 110. Hence, network devices of subnet 110 can communicate with devices outside of subnet 110 via network device 112. Subnet 110 can be coupled to a network management system 150 via a wide-area network (WAN) 160, such as an enterprise network or the Internet. An NMS 150, which can be a network orchestrator, can configure a respective switch in network 100. NMS 150 can be a cloud-based system operating on a management server 140. NMS 150 can operate on a network controller or a software-defined network (SDN) controller. NMS 150 can control the management plane of the network. To do so, an administrator can use NMS 150 (e.g., using a dashboard or console) to configure the operating parameters based on which the switches in network 100 may operate. Examples of the operating parameters can include, but are not limited to, VLAN, port configuration, routing, and forwarding parameters.

With existing technologies, each subnet of network 100 can deploy network loop prevention and detection protocols, such as STP. Loop formation in the VLAN associated with subnet 110 can be prevented by operating an instance of STP on each network device. Moreover, if a network exists in subnet 110, network device 112 may detect the loop if network device 112 receives a packet originally sent by network device 112. Network device 112 can identify such a packet if the packet's source address corresponds to the address of network device 112. Nevertheless, these protocols and techniques are not able to determine the loop path. The loop may be caused by a configuration error on any of the network devices in the loop path. Therefore, even if network device 112 detects the loop, it may not be caused by any misconfiguration on network device 112. As a result, an administrator might not easily identify a configuration error in subnet 110 that has caused the loop.

To address this problem, each of network devices 112, 114, 116, and 118 may perform loop-path tracing by sending a probe packet on the VLAN associated with subnet 110. Since device 102 is an external device, device 102 may not participate in the loop-path tracing. The network device originally sending a probe packet can be the OND for the probe packet. For example, network device 112 can send a probe packet 120 to subnet 110. Hence, network device 112 can also be referred to as OND 112. Probe packet 120 can be a layer-2 multi-destination packet. The source and destination addresses of probe packet 120 can be the address of OND 112 and a multi-destination address, respectively. Probe packet 120 can also include a VLAN tag identifying the VLAN associated with subnet 110. OND 112 can include a data set 122 associated with OND 112 into the payload of probe packet 120. Data set 122 can include the address of OND 112 and the identifier of the port egressing probe packet 120. OND 112 can set the value of a hop count 130 to 1.

Data set 122 can be encoded in a TLV field in probe packet 120. Data set 122 can be included in one TLV field, or each piece of information in data set 122 can be included in a separate TLV field. OND 112 can then forward probe packet 120 to network device 114 via a local port configured with the VLAN. Network device 114 can determine that the source address of probe packet 120 is not a local address allocated to network device 114. Network device 114 can also identify it as a probe packet based on a type of probe packet 120. If probe packet 120 is an Ethernet frame, the type can be indicated by a predefined value for the Ethertype field of the header of probe packet 120. Network device 114 can include data set 124 associated with network device 114 into the payload of probe packet 120. Data set 124 can be appended to data set 122 in probe packet 120. Network device 114 can also increment the value of hop count 130 to 2.

Device 102 may receive probe packet 120 from network device 114. However, device 102 may not support the packet format of probe packet 120. Nonetheless, device 102 can still flood probe packet 120 in subnet 110 without appending its data set. As a result, network device 116 can receive probe packet 120. However, the value of hop count 130 may remain at 2. Network device 116 can append its local data set 126 to the payload of probe packet 120 and increment the value of hop count 130 to 3. Network device 116 can then forward probe packet 120 to network device 118.

If there is a loop in subnet 110, network device 118 can forward probe packet 120 back to OND 112. Prior to the forwarding, network device 118 can append data set 128 to the payload of probe packet 120 and increment the value of hop count 130 to 4. OND 112 can parse the appended data sets in the payload of probe packet 120 to determine that probe packet 120 has been forwarded by network devices 114, 116, and 118 before returning to OND 112. Accordingly, OND 112 can determine the trace path of the loop. OND 112 can then present the trace path to a network administrator for a mitigating action. For example, OND 112 can provide the trace path to NMS 150, which can then present it to the administrator via an interface. The administrator can then analyze the network devices on the loop path and determine the mitigating action (e.g., disabling a port).

FIG. 1B illustrates an example of determining the trace path of a loop in a network based on a probe packet, in accordance with an aspect of the present application. When OND 112 receives probe packet 120 back, the payload of probe packet 120 can include data sets 122, 124, 126, and 128. Data set 122 can include a layer-2 address 132 (e.g., a MAC address) of network device 112 and a port identifier of egress port 152 via which probe packet 120 is forwarded to network device 114. Data set 122 can also include neighbor information of a neighbor device reachable via port 152. The neighbor information can be obtained based on LLDP. Furthermore, data set 124 can include a layer-2 address 134 of network device 114 and respective identifiers of ingress port 154 and egress port 156. Here, network device 114 can receive probe packet 120 via port 154 and send it via port 156 to device 102. Accordingly, data set 124 can also include neighbor information of respective neighbor devices reachable via ports 154 and 156.

Because device 102 does not participate in the path tracing, when network device 114 sends probe packet 120 via port 156, device 102 can flood probe packet 120. Network device 116 can receive probe packet 120 via port 158 and send probe packet 120 via port 160. Accordingly, data set 126 can include a layer-2 address 136 of network device 116 and respective identifiers of ingress port 158 and egress port 160. Data set 126 can also include neighbor information of respective neighbor devices reachable via ports 158 and 160. Network device 118 can receive probe packet 120 via port 162 and send it via port 164 to OND 112. Hence, data set 128 can include a layer-2 address 138 of network device 116 and respective identifiers of ingress port 162 and egress port 164. In addition, data set 128 can include neighbor information of respective neighbor devices reachable via ports 162 and 164.

Upon receiving probe packet 120 back via port 166, OND 112 can determine that the source address of probe packet 120 is address 132. Therefore, OND 112 can determine that probe packet 120 has originated from OND 112. OND 112 can then retrieve the data sets from the payload and parse the retrieved data sets. OND 112 can include the identifier of port 166 as the ingress port identifier in data set 122 upon receiving probe packet 120 back. Since network devices 112, 114, 116, and 118 sequentially append corresponding data sets, the retrieved data sets can indicate the sequence of network devices in the loop path starting from OND 112. For each network device of the sequence, the data sets can also indicate which ports have received and forwarded the probe packet.

In addition, based on the neighbor information, OND 112 can determine whether there is any additional device between two network devices in the sequence. For example, OND 112 can determine that the neighbor information in data set 124 does not correspond to network device 116. Accordingly, OND 112 can determine that when probe packet 120 is forwarded via port 156 of network device 114 and received via port 158 of network device 116, there is an external device that forwarded probe packet 120. Based on the sequence of network devices 112, 114, 116, and 118, and their corresponding sequence of ingress and egress ports 152, 154, 156, 158, 160, 162, 164, and 166, OND 112 can determine the trace path of the loop.

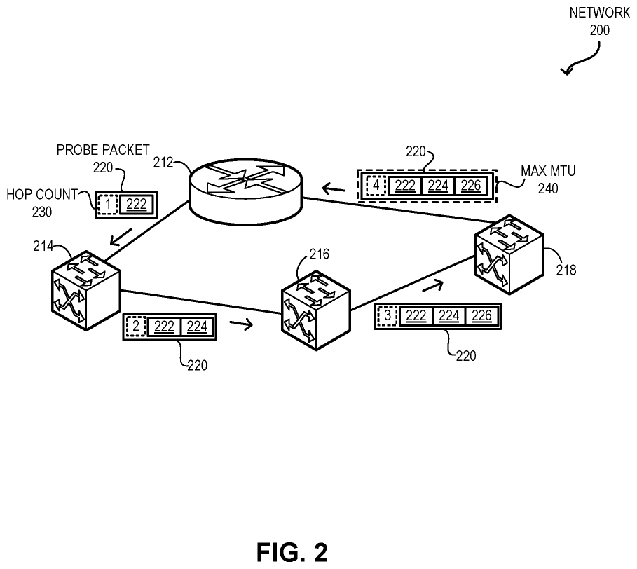

FIG. 2 illustrates an example of a probe packet with an MTU traversing a network to trace the path of a loop, in accordance with an aspect of the present application. A network 200 can include network devices 212, 214, 216, and 218. To determine whether a loop exists in network 200, network device 212, operating as an OND, can send a probe packet 220 to network 200. OND 212 can include a data set 222 associated with OND 212 into the payload of probe packet 220. OND 212 can set the value of hop count 230 to 1 and forward probe packet 220 to network device 214. Upon receiving probe packet 220, network device 214 can append data set 224 associated with network device 214 in the payload of probe packet 220. Network device 214 can also increment the value of hop count 230 to 2 and forward probe packet 220 to network device 216.

Network device 216 can append data set 226 associated with network device 216 into the payload of probe packet 220. Network device 216 can increment the value of hop count 230 to 3 and forward probe packet 220 to network device 218. Upon receiving probe packet 220, network device 218 can determine that probe packet 220 has reached its MTU 240. For example, if probe packet 220 is a multi-destination Ethernet packet, MTU 240 can be 1518 bytes for packet 220. Network device 218 can then refrain from appending the data set associated with network device 218 in the payload of probe packet 220. However, network device 218 can increment the value of hop count 230 to 4 and forward probe packet 220 back to OND 212. By precluding network device 218 from appending the information, network device 218 can allow probe packet 220 to operate within the limitation of the underlying protocol (e.g., the Ethernet protocol). Furthermore, network device 218 can still forward probe packet 220 in network 200 so that probe packet 220 can eventually reach OND 212.

Upon receiving probe packet 220 back, OND 212 can determine that the source address of probe packet 220 is the local address of OND 212. Therefore, OND 212 can determine that probe packet 220 has originated from OND 212. OND 212 can then retrieve the data sets from the payload and parse the retrieved data sets. OND 212 can determine that the value of hop count 230 is 4 while the number of TLVs in probe packet 220 is 3. OND 212 can then determine that the trace path comprising network devices 212, 214, and 216 indicates a partial trace. OND 212 may combine data sets from other probe packets to determine the entire trace path of the loop.

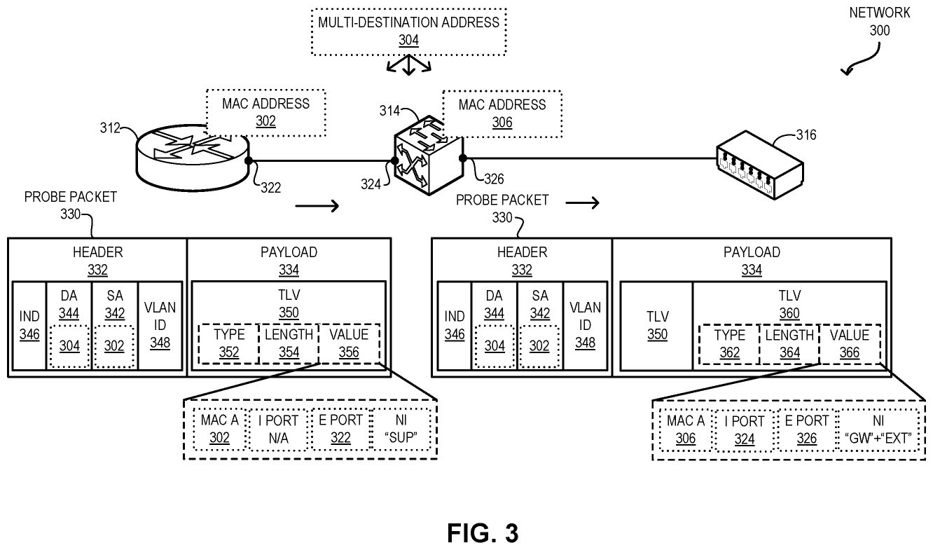

FIG. 3 illustrates examples of trace data accumulation in a probe packet, in accordance with an aspect of the present application. A network 300 can include network devices 312, 314, and 316. To determine whether a loop exists in network 300, network device 312, operating as an OND, can send a probe packet 330 to network 300. Probe packet 330 can include a header 332 and a payload 334. Header 332 can include a source address 342, a destination address 344, an indicator 346 that identifies packet 330 as a probe packet, and a VLAN identifier 348. Probe packet 330 can be a layer-2 multi-destination packet. Because network device 312 can be the OND, source address 342 and destination address 344 can be MAC address 302 of network device 312 and a multi-destination address 304, respectively. VLAN identifier 348 can identify the VLAN in which a loop is probed.

Payload 334 can include a TLV 350 comprising a type field 352, a length field 354, and a value field 356. Type field 352 can indicate that TLV 350 includes a data set associated with a network device, such as network device 312. Length 354 can indicate the number of bytes in value field 356. Value field 356 can include MAC address 302 of network device 312, an identifier of egress port 322 of network device 312, and neighbor information indicating that neighboring network device 314 supports path tracing. Network device 312 can determine the neighbor information based on information obtained using LLDP. For example, the device model from the neighbor information can indicate whether path tracing is supported by a neighbor device. Value 356 can also comprise an ingress port identifier, which can include a “not applicable” value because network device 312 can be the OND.

Network device 312 can send probe packet 330 to network device 314 via egress port 322. Network device 314 can receive probe packet 330 via ingress port 324, append a TLV 360 comprising the data set associated with network device 314 in payload 334, and send probe packet 330 via egress port 326. TLV 360 can include a type field 362, a length field 364, and a value field 366. Type field 362 can indicate that TLV 360 includes a data set associated with network device 314. Length 364 can indicate the number of bytes in value field 366. Value field 366 can include MAC address 306 of network device 314, respective identifiers of ingress port 324 and egress port 326 of network device 314, and neighbor information indicating that neighboring network device 312 is a gateway device and network device 316 is an external device that may not support path tracing. In this way, probe packet 330 can continue to accumulate data sets associated with individual network devices in a loop path in network 300.

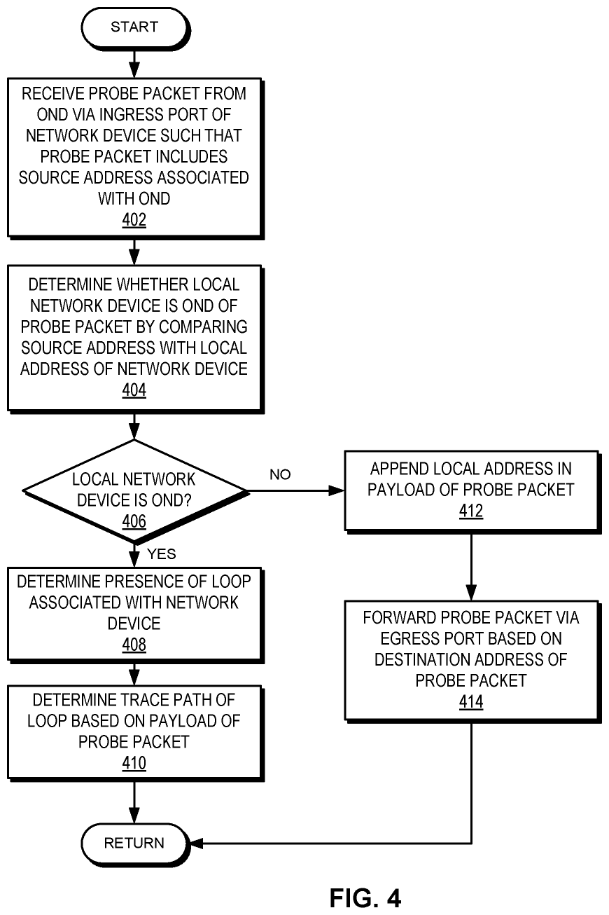

FIG. 4 presents a flowchart illustrating the process of a network device determining the trace path of a loop in a network, in accordance with an aspect of the present application. During operation, the network device can receive a probe packet from an OND via an ingress port of the network device such that the probe packet includes a source address associated with the OND (operation 402). The probe packet can be a layer-2 multi-destination packet. Hence, the probe packet can be flooded in the network. If the loop exists in the network, the flooding allows the probe packet to loop back to the OND. Furthermore, the source address allows the OND to identify that the packet has been sent from the OND. The network device can then determine whether the local network device (i.e., the network device performing the process) is the OND of the probe packet by comparing the source address with the local address of the network device (operation 404). A looped-back packet at the network device can previously be sent from that same network device. Therefore, by comparing the source address with the local address, the network device can check whether the probe packet has previously been sent from that network device.

The network device can then determine whether the local network device is the OND (operation 406). If the source address of the probe packet matches the local address, the network device can determine that the probe packet has originated from the local network device (i.e., the local network device is the OND for the probe packet). If the local network device is the OND, the network device can determine the presence of a loop associated with the network device (operation 408). The local network device being the OND for the probe packet indicates that the packet has looped back to the network device, and hence, a loop has been detected in the network. Because the loop can be detected at the network device, the association between the loop and the network device can indicate that the network device is in the loop.

The network device can then determine the trace path of the loop based on the payload of the probe packet (operation 410). Because a respective network device forwarding the probe packet can append its address in the probe packet, the probe packet can include respective addresses of the sequence of network devices that have forwarded the probe packet. As a result, if the network device receives the probe packet back on a loop, the network device can determine the trace path of the loop by tracing the path formed by the sequence of network devices.

On the other hand, if the local network device is not the OND, the local network device can be a network device on the loop path. Accordingly, the network device can append the local address in the payload of the probe packet (operation 412). By appending the local address, the network device can indicate that the local address is on the loop path. Moreover, the network device can also provide identifying information of the network device, which can then be used for determining the trace path. The network device can then forward the probe packet via an egress port of the network device based on the destination address of the probe packet (operation 414). Since the destination address can be a multi-destination address, the probe packet can be flooded by the network device where the egress port can be one of the ports.

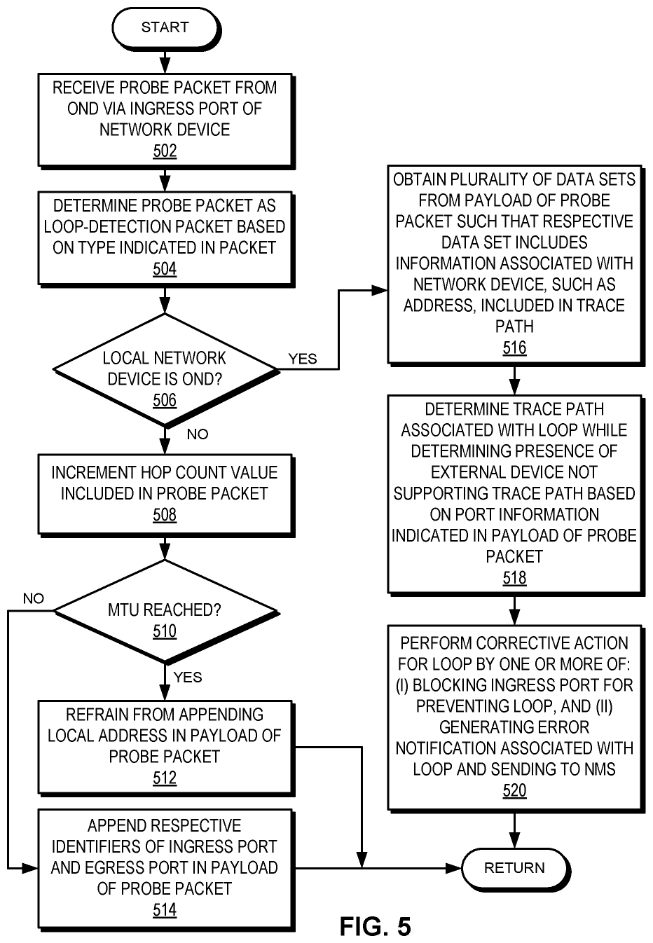

FIG. 5 presents a flowchart illustrating the process of a network device processing a probe packet for determining the trace path of a loop in a network, in accordance with an aspect of the present application. During operation, the network device can receive a probe packet from an OND via an ingress port of the network device (operation 502). Because the packet is a probe packet, the source address of the probe packet can be the address of the OND, and the type of the packet can indicate that the probe packet is a loop-detection packet. Accordingly, the network device can determine the probe packet as a loop-detection packet based on the type in the packet (operation 504). If the probe packet is an Ethernet packet, the type can be indicated by a predetermined Ethertype value of the Ethernet header. If the network device supports path tracing, the network device can recognize the type from the header of the probe packet and perform subsequent operations, such as appending local information in the probe packet.

The network device can then determine whether the local network device is the OND (operation 506). Since the source address of the probe packet can be the address of the OND, if the source address matches a local address of the network device, the network device can identify the local network device as the OND. If the local network device is the OND, the network device can determine the existence of a loop in the network. The network device can then obtain a plurality of data sets from the payload of the probe packet such that a respective data set includes information associated with the network device, such as the address (e.g., a MAC address) included in the trace path (operation 516). The plurality of data sets can indicate a sequence of network devices that have forwarded the probe packet. Consequently, because the network device has received the probe packet back on a loop, the network device can determine the trace path of the loop by tracing the path formed by the sequence of network devices.

The plurality of data sets can also include port identifiers and neighbor information associated with corresponding network devices. This allows the network device to recognize whether the probe packet has passed through an external device. Even though the external device may not append a data set to the payload of the probe packet, the neighbor information and the port identifiers can indicate the presence of the external device. Accordingly, the network device can determine the trace path associated with the loop while determining the presence of an external device not supporting the trace path based on the port information indicated in the payload of the probe packet (operation 518). The network device can then perform a corrective action for the loop (i.e., to prevent or “break” the loop). The corrective action can include one or more of: (i) blocking the ingress port of the probe packet for preventing the loop, and (ii) generating an error notification associated with the loop and sending it to an NMS (operation 520). The notification can include the path trace of the loop. The network device can provide the notification to the NMS. An administrator can then analyze the path trace to identify the configuration error causing the loop and perform a mitigating action.

On the other hand, if the local network device is not the OND, the network device may be a network device in the loop path. The network device can also increment the hop count value included in the probe packet (operation 508). By incrementing the hop count value, the network device can allow the OND of the probe packet to determine the number of network devices that support the path tracing in the trace path. The OND may use the hop count value to determine the number of TLVs in the payload of the probe packet. The network device can then determine whether the MTU is reached for the probe packet (operation 510). The MTU can determine the maximum length of the probe packet based on the protocol associated with the probe packet. For example, if the probe packet is an Ethernet packet, the maximum length of the probe packet can be 1518 bytes, as indicated by the Ethernet protocol.

If the MTU is reached, the probe packet cannot accommodate the data set associated with the network device. Accordingly, the network device can refrain from appending the local address (and other information) in the payload of the probe packet (operation 512). By precluding the network device from appending the local address, the network device can allow the probe packet to operate within the limitation of the underlying protocol (e.g., the Ethernet protocol). Furthermore, the network device can still forward the probe packet in the network so that the probe packet can eventually reach the OND. On the other hand, if the MTU is not reached, the probe packet can accommodate the data set associated with the network device. The network device can then append the data set associated with the network device. Appending the data set can include appending respective identifiers of the ingress port and egress port in the payload of the probe packet (operation 514).

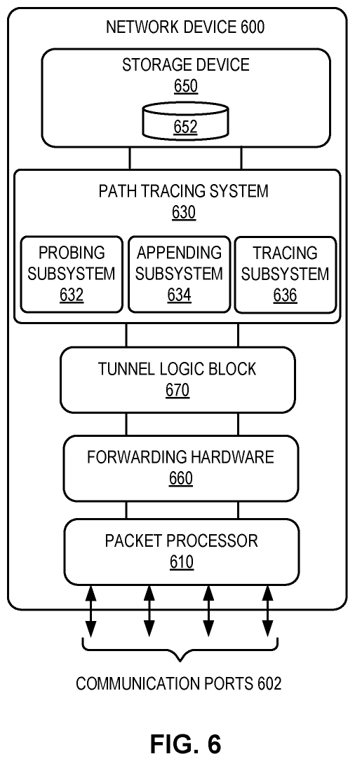

FIG. 6 illustrates an example of a network device that supports tracing the path of a loop in a network, in accordance with an embodiment of the present application. A network device 600 can include a number of communication ports 602, a packet processor 610, and a storage device 650. Network device 600 can also include forwarding hardware 660 (e.g., processing hardware of network device 600, such as its application-specific integrated circuit (ASIC) chips), which includes information based on which network device 600 processes packets (e.g., determines output ports for packets). Packet processor 610 extracts and processes header information from the received packets. Packet processor 610 can identify a switch identifier (e.g., a MAC address and/or an IP address) associated with network device 600 in the header of a packet.

Communication ports 602 can include inter-switch communication channels for communication with other switches and/or user devices. The communication channels can be implemented via a regular communication port and based on any open or proprietary format. Communication ports 602 can include one or more Ethernet ports capable of receiving frames encapsulated in an Ethernet header. Communication ports 602 can also include one or more IP ports capable of receiving IP packets. An IP port is capable of receiving an IP packet and can be configured with an IP address. Packet processor 610 can process Ethernet frames and/or IP packets. A respective port of communication ports 602 may operate as an ingress port and/or an egress port. If network device 600 is in a fabric, network device 600 can include a tunnel logic block 670 that can operate network device 600 as a tunnel endpoint (e.g., by initiating and terminating tunnel encapsulation) in the fabric.

Network device 600 can maintain a database 652 (e.g., in storage device 650). Database 652 can be a relational database and may run on one or more database management system (DBMS) instances. Database 652 can store information associated with routing and configuration associated with network device 600. Network device 600 can operate a path tracing system 630 that facilitates layer-2 path tracing of a loop in a network. Path tracing system 630 can include a probing subsystem 632, appending subsystem 634, and tracing subsystem 636. A respective subsystem can include instructions executable by network device 600 to perform one or more operations.

Probing subsystem 632 can include instructions to initiate path tracing by generating a probe packet. Probing subsystem 632 can include instructions to set a local address (e.g., a MAC address) of network device 600 as the source of the probe packet and select network 600 as the OND for the probe packet. On the other hand, if network device 600 receives a probe packet from another OND (i.e., the source address does not match the local address), appending subsystem 634 can include instructions to append the data set associated with network device 600 in the payload of the probe packet. Appending the data set can include appending the local address, respective identifiers of the ingress port and egress port, and the neighbor information in the payload of the probe packet.

Probing subsystem 632 can also include instructions to determine that a probe packet has looped back to network device 600 by matching the source address of the packet with the local address. The plurality of data sets in the probe packet can indicate a sequence of network devices that have forwarded the probe packet. Consequently, because network device 600 has received the probe packet back on a loop, tracing subsystem 636 can include instructions to determine the trace path of the loop by tracing the path formed by the sequence of network devices.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device that can trace the path of a loop in a network. During operation, the network device can receive a probe packet from an originating network device via an ingress port of the network device. Here, the probe packet can include a source address associated with the originating network device. The network device can then determine whether the network device is the originating network device of the probe packet by comparing the source address with a local address of the network device. Upon determining that the network device is not the originating network device, the network device can append the local address in a payload of the probe packet and forward the probe packet via an egress port based on the destination address of the probe packet. On the other hand, upon determining that the network device is the originating network device, the network device can determine the presence of a loop associated with the network device and determine a trace path of the loop based on the payload of the probe packet.

In a variation on this aspect, upon determining that the network device is the originating network device, the network device can perform a corrective action associated with the loop. The corrective action can include one or more of. (i) blocking the ingress port for preventing the loop, and (ii) generating an error notification associated with the loop.

In a variation on this aspect, the network device can determine the probe packet as a loop detection packet based on a type of the packet.

In a variation on this aspect, upon determining that the network device is not the originating network device, the network device can append respective identifiers of the ingress port and the egress port in the payload of the probe packet.

In a variation on this aspect, the network device can determine the trace path by determining presence of a remote network device not supporting the trace path based on port information indicated in the payload of the probe packet.

In a variation on this aspect, the payload of the probe packet can include a plurality of data sets. Here, a respective data set can include information associated with a network device included in the trace path. Such information can include an address of the network device in the trace path.

In a further variation, a respective data set can be represented in the probe packet based on one of: (i) a type-length-value (TLV) encoded field comprising the information associated with the network device of the data set, and (ii) a set of TLVs, each representing a piece of information associated with the network device of the data set.

In a variation on this aspect, upon determining that the network device is not the originating network device, the network device can increment a hop count value included in the probe packet.

In a further variation, the network device can determine whether the maximum length of the probe packet is reached. Upon determining that the maximum length of the probe packet is reached, the network device can refrain from appending the local address in the payload of the probe packet.

In a variation on this aspect, the probe packet includes an indicator indicating support of the trace path.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method comprising:
receiving, by a network device, a probe packet from an originating network device via an ingress port of the network device, wherein the probe packet includes a source address associated with the originating network device;
determining, by the network device, whether the network device is the originating network device of the probe packet by comparing the source address with a local address of the network device;
in response to determining that the network device is not the originating network device:
appending the local address in a payload of the probe packet; and
forwarding the probe packet via an egress port based on a destination address of the probe packet; and
in response to determining that the network device is the originating network device:
determining presence of a loop associated with the network device; and
determining a trace path of the loop based on the payload of the probe packet.

2. The method of claim 1, wherein, in response to determining that the network device is the originating network device, the method further comprises performing a corrective action associated with the loop, wherein the corrective action includes one or more of:
blocking the ingress port for preventing the loop; and
generating an error notification associated with the loop.

3. The method of claim 1, further comprising determining the probe packet as a loop detection packet based on a type of the packet.

4. The method of claim 1, wherein, in response to determining that the network device is not the originating network device, the method further comprises appending respective identifiers of the ingress port and the egress port in the payload of the probe packet.

5. The method of claim 1, wherein determining the trace path further comprises determining presence of a remote network device not supporting the trace path based on port information indicated in the payload of the probe packet.

6. The method of claim 1, wherein the payload of the probe packet comprises a plurality of data sets, wherein a respective data set includes information associated with a network device included in the trace path, and wherein the information includes an address of the network device in the trace path.

7. The method of claim 6, wherein a respective data set is represented in the probe packet based on one of:
a type-length-value (TLV) encoded field comprising the information associated with the network device of the data set; and
a set of TLVs, each representing a piece of information associated with the network device of the data set.

8. The method of claim 1, wherein, in response to determining that the network device is not the originating network device, the method further comprises incrementing a hop count value included in the probe packet.

9. The method of claim 8, further comprising:
determining whether a maximum length of the probe packet is reached; and
in response determining that the maximum length of the probe packet is reached, refraining from appending the local address in the payload of the probe packet.

10. The method of claim 1, wherein the probe packet includes an indicator indicating support of the trace path.

11. A non-transitory computer-readable storage medium storing instructions that when executed by a processor of a network device cause the network device to perform a method, the method comprising:
receiving a probe packet from an originating network device via an ingress port of the network device, wherein the probe packet includes a source address associated with the originating network device;
determining whether the network device is the originating network device of the probe packet by comparing the source address with a local address of the network device;
in response to determining that the network device is not the originating network device:
appending the local address in a payload of the probe packet; and
forwarding the probe packet via an egress port based on a destination address of the probe packet; and
in response to determining that the network device is the originating network device:
determining presence of a loop associated with the network device; and
determining a trace path of the loop based on the payload of the probe packet.

12. The non-transitory computer-readable storage medium of claim 11, wherein, in response to determining that the network device is the originating network device, the method further comprises performing a corrective action associated with the loop, wherein the corrective action includes one or more of:
blocking the ingress port for preventing the loop; and
generating an error notification associated with the loop.

13. The non-transitory computer-readable storage medium of claim 11, further comprising determining the probe packet as a loop detection packet based on a type of the packet.

14. The non-transitory computer-readable storage medium of claim 11, wherein, in response to determining that the network device is not the originating network device, the method further comprises appending respective identifiers of the ingress port and the egress port in the payload of the probe packet.

15. The non-transitory computer-readable storage medium of claim 11, wherein determining the trace path further comprises determining presence of a remote network device not supporting the trace path based on port information indicated in the payload of the probe packet.

16. The non-transitory computer-readable storage medium of claim 11, wherein the payload of the probe packet comprises a plurality of data sets, wherein a respective data set includes information associated with a network device included in the trace path, and wherein the information includes an address of the network device in the trace path.

17. The non-transitory computer-readable storage medium of claim 16, wherein a respective data set is represented in the probe packet based on one of:
a type-length-value (TLV) encoded field comprising the information associated with the network device of the data set; and
a set of TLVs, each representing a piece of information associated with the network device of the data set.

18. The non-transitory computer-readable storage medium of claim 11, wherein, in response to determining that the network device is not the originating network device, the method further comprises incrementing a hop count value included in the probe packet.

19. The non-transitory computer-readable storage medium of claim 18, further comprising:
determining whether a maximum length of the probe packet is reached; and
in response determining that the maximum length of the probe packet is reached, refraining from appending the local address in the payload of the probe packet.

20. A computer system, comprising:
a processor;
a set of ports;
a communication port to receive a probe packet from an originating network device via an ingress port in the set of ports, wherein the probe packet includes a source address associated with the originating network device; and
a non-transitory computer-readable storage medium storing instructions that when executed by the processor cause the computer system to:
determine whether the computer system is the originating network device of the probe packet by comparing the source address with a local address of the computer system;
in response to determining that the computer system is not the originating network device:
append the local address in a payload of the probe packet; and
forward the probe packet via an egress port based on a destination address of the probe packet; and
in response to determining that the computer system is the originating network device:
determine presence of a loop associated with the computer system; and
determine a trace path of the loop based on the payload of the probe packet.
